(19) United States
(12) Patent Application Publication
(10) Pub. No.: US 2005/0276039 A1
(43) Pub. Date: Dec. 15, 2005

(54) Garbage disposal tool

(76) Inventor: George L. Hillenbrand, Petaluma, CA (US)

Correspondence Address: GEORGE L. HILLENBRAND, 18 PALOMINO CT, PETALUMA, CA, 94954, US

(21) Appl. No.: 10/865,332

(22) Filed: Jun. 11, 2004

(51) Int. Cl. B02B 1/00

(52) U.S. Cl. 362/120

(57) ABSTRACT

A garbage disposal tool with a scissors like configuration consisting of a pair of members that are centrally pinned together by a shaft in a standard fashion, each having a standard finger gripping handle at one side of the pinned shaft and an elongate end approximately eight and one half inches long terminating in an inwardly facing resilient member at the opposite end of the pinned shaft, and and a downwardly aiming standard light emitting device attached to one side of the elongate member so that the light can illuminate the area in proximity to the resilient tips. A preferred embodiment includes an annular ring capable of holding open the standard radially displaced rubber flaps found at the mouth of a standard garbage disposal.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of kitchen sink accessories and more specifically to a garbage disposal tool.

For as long as man has been preparing food for consumption there has been a need to effectively discard unwanted food items after the food preparation process is complete. In the past thirty years the use of garbage disposals have become very popular. A standard garbage disposal is installed under the drain of a standard kitchen sink. The disposal includes a tubular passage located just under the sink drain approximately six inches deep terminating in a motorized blade assembly that can effectively chop up debris so that it can easily flow down the drain of the sink along with waste water. Unfortunately, there are times when an item accidentally drops down into the mouth of the disposal and needs to be retrieved. To do this, a person must place his or her hand into the mouth of the disposal and try to retrieve the item with the tips of his or her fingers. This activity is problematic for several reasons. First, there is an obvious danger in placing ones hand and fingers deep in the mouth of a disposal whose blades are designed to pulverize items so that they can easily flow down the drain pipe of the sink. Second, many people have hands that are to large to fit in the mouth of a standard disposal. Third, the act of inserting ones fist into a disposal makes it difficult to see the item to be retrieved. Finally, the item to be retrieved may be dangerous to pick up with unprotected fingers such as pieces of broken glass.

### BRIEF SUMMARY OF THE INVENTION

The primary object of the invention is to provide a garbage disposal tool that enables a person to retrieve items that are located at the bottom, blade portion of a standard garbage disposal found in many kitchen sinks.

Another object of the invention is to provide a garbage disposal tool that includes a device that spreads apart the rubber flaps found in most standard garbage disposals.

Another object of the invention is to provide a garbage disposal tool that includes a light emitting source to allow the user to better see items that have fallen into the disposal orifice.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed garbage disposal tool comprising: a scissors like configuration consisting of a pair of members that are centrally pinned together by a shaft in a standard fashion, each having a standard finger gripping handle at one side of said pinned shaft and an elongate member approximately eight and one half inches long terminating in an inwardly facing resilient member at the opposite end of said pinned shaft, and and a downwardly aiming standard light emitting device attached to one side of said elongate member so that said light can illuminate the area in proximity to said resilient tips.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a plan view of the invention in the closed position.

FIG. 2 is a plan view of the invention in the open position.

FIG. 3 is a side view of the invention.

FIG. 4 is a perspective view of a person inserting an annular ring into a standard sink drain.

FIG. 5 is a side section view of the invention in use.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

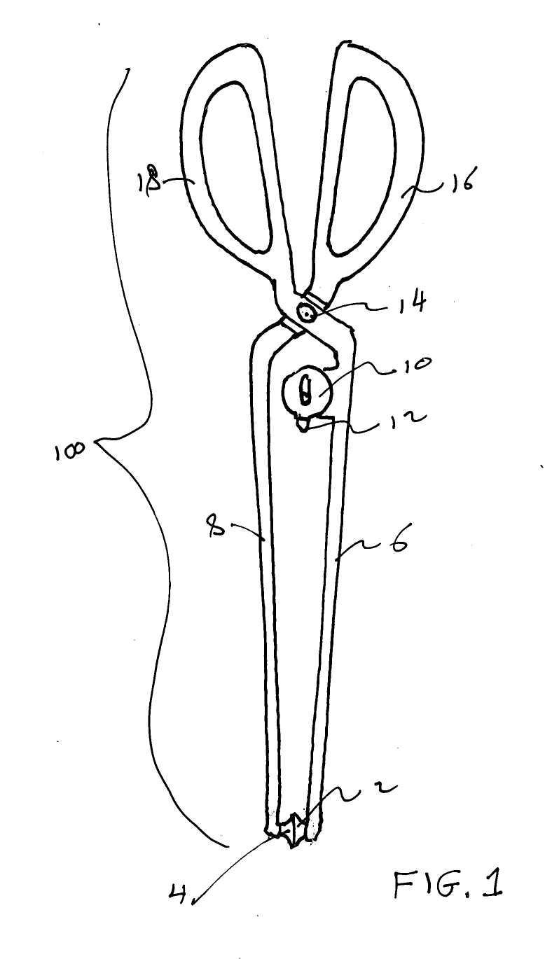

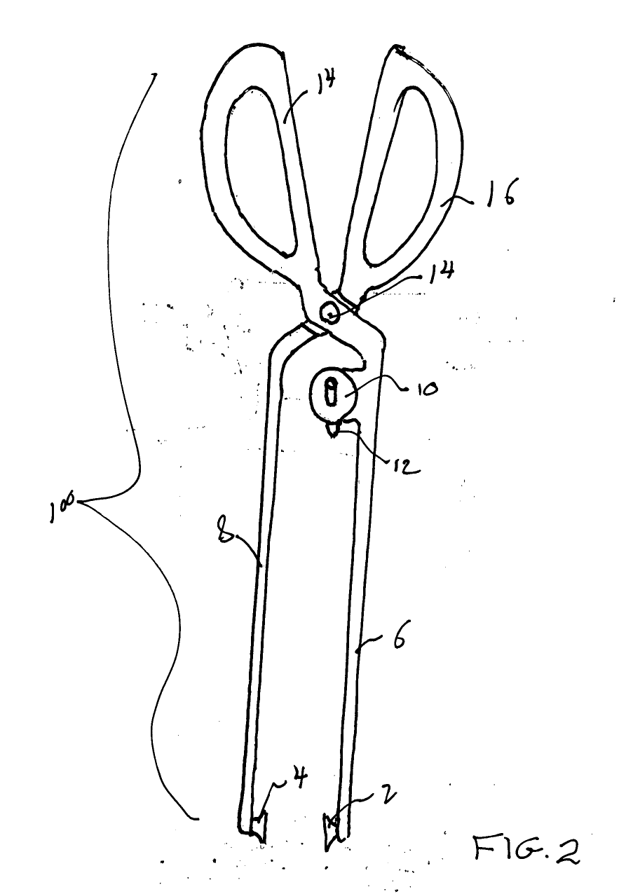

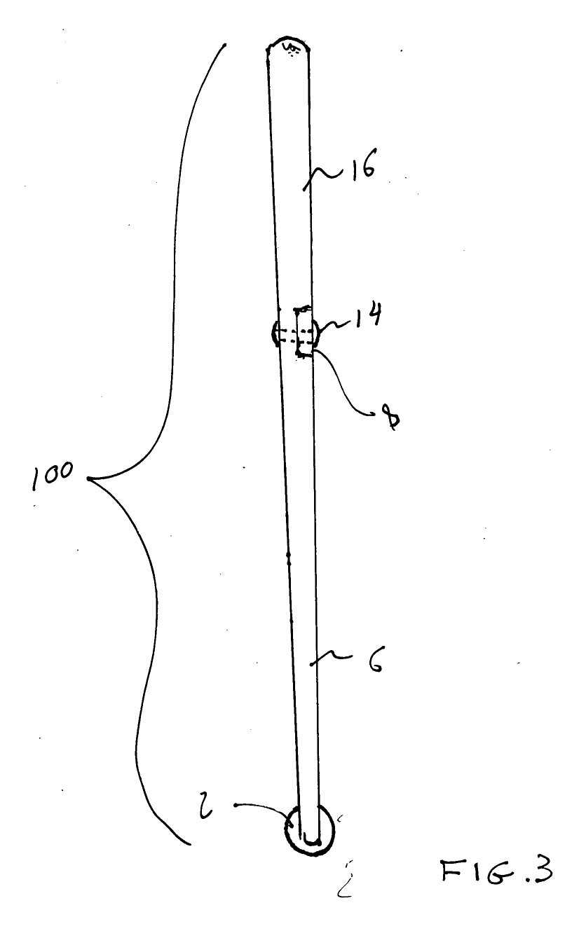

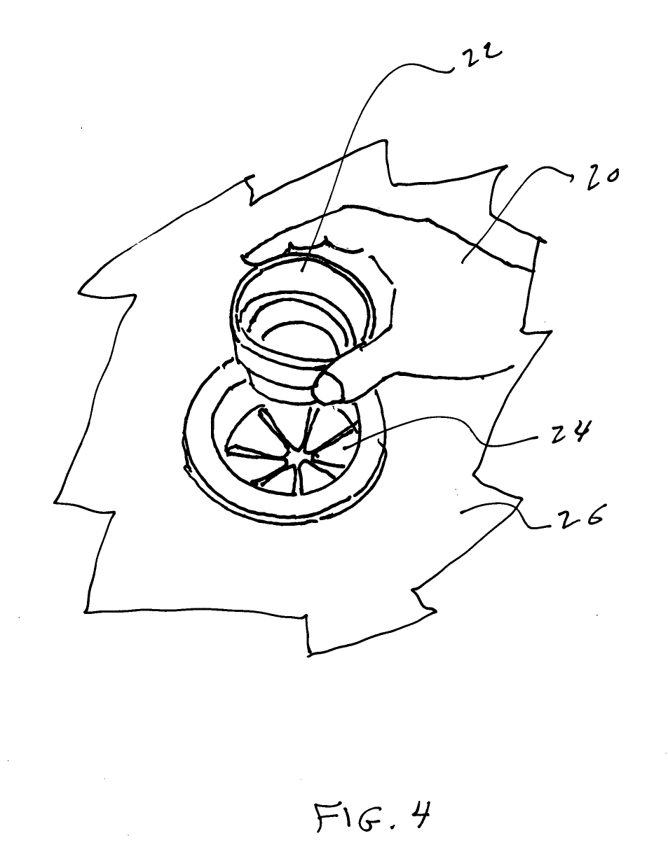

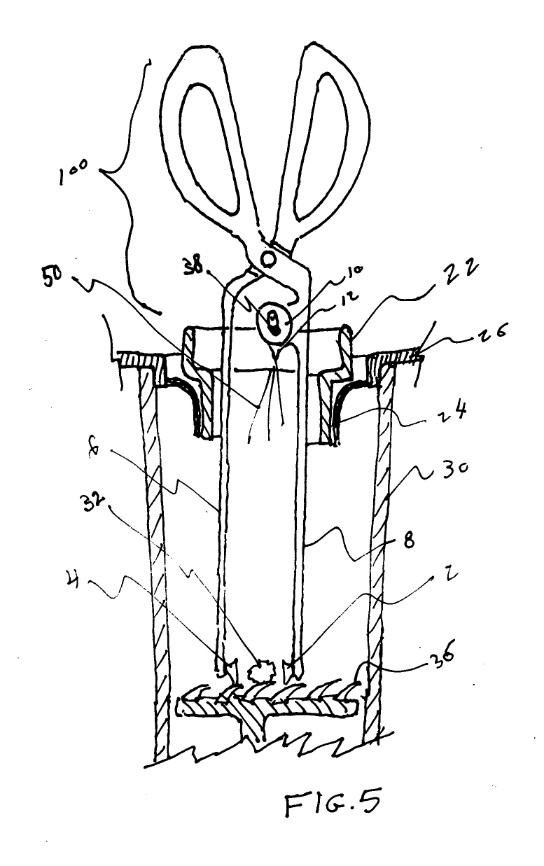

Referring now to FIG. 1 we see a plan view of the present invention 100. The invention is constructed in a similar fashion to a standard scissors. It is comprised of a handle portion 16, 18 that is grasped by a person just as he or she would grasp a scissors, and a pair of elongate members 6, 8 that terminate in a pair of resilient inwardly facing tips 2, 4. The two, mirror image members of the invention are centrally pinned 14 as in a standard scissors or pliers. An illuminating means 12 including housing, on-off switch and housing 10 is attached to one of the elongate members as shown. The scissors like assembly is constructed of rigid material such as plastic or metal such as steel. A preferred embodiment shows the invention being constructed of injection molded transparent polycarbonate so that the user has more visability when attempting to retrieve an item that has fallen into a standard kitchen sink garbage disposal. The length of elongate members 6, 8 from pin 14 to the bottom of resilieant tip 4 is approximately eight and one half inches long so that they can easily reach items located six inches down at the blade portion of a standard garbage disposal. FIG. 2 shows a plan view of the invention in the open position. The thin cross section of each elongate member 6, 8 allows the members 6, 8 to be opened to maximum position within the tubular throat of a standard garbage disposal. FIG. 3 is a side view of the invention. This view shows that the resilient tips are circular in this embodiment, however the tips may also be square and flat sided. This view also shows how pin 14 includes retaining heads that slidably holds members 6 and 8 together. FIG. 4 shows a perspective view of a person 20 about to insert an annular ring 22 into the rubber 24 flaps that are found in most standard garbage disposals that are centrally mounted to a sink 26 drain. FIG. 5 shows a side section view of the invention in use. Rubber flaps 24 attached to sink 26 have been forced down by ring 22. Tool 100 is inserted into the throat 30 of the disposal. Elongate members 6, 8 reach down into disposal 30 to retrieve an article 32 resting on the blade portion 36 of the disposal. Illuminating means 12, is turned on by switch 38. The light 50 can shine directly down on the item 32 to be retrieved thereby making it easier to locate the item the resilient tips 2, 4 allow the user to pick up small and irregular shaped objects. It should be noted that the tool 100 of the present invention can also be used by a person to pick up any object off the floor thereby reducing the distance a person has to bend over. This is especially beneficial to those who have back problems or other maladies that make it difficult to fully bend over.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A garbage disposal tool comprising:
a scissors like configuration consisting of a pair of members that are centrally pinned together by a shaft in a standard fashion, each having a standard finger gripping handle at one side of said pinned shaft and an elongate end approximately eight and one half inches long terminating in an inwardly facing resilient member at the opposite end of said pinned shaft; and
and a downwardly aiming standard light emitting device attached to one side of said elongate member so that said light can illuminate the area in proximity to said resilient tips.

2. A garbage disposal tool as claimed in claim 1 further comprising an annular ring capable of holding open the standard radially displaced rubber flaps found at the mouth of a standard garbage disposal

3. A garbage disposal tool as claimed in claim 1 wherein said light emitting device is comprised of a high intensity LED, a switch for turning said LED on or off, a battery and a housing.

4. A garbage disposal tool as claimed in claim 1 wherein said resilient tips resemble small suction cups where said suction cups face each other causing the edges of the said suction cups to meet and to be able to pick up a variety of irregularly shaped objects that may be accidentally residing atop the blade portion of a standard garbage disposal.
